(19) United States
(12) Patent Application Publication
(10) Pub. No.: US 2020/0254291 A1
(43) Pub. Date: Aug. 13, 2020

(54) SPRAYABLE FOAMED ROCK DUST COMPOSITION AND METHOD OF USING THE SAME

(71) Applicant: ALLIED FOAM TECH CORP., Montgomeryville, PA (US)

(72) Inventor: Yen-Yau H. CHAO, Harleysville, PA (US)

(21) Appl. No.: 16/862,450

(22) Filed: Apr. 29, 2020

Related U.S. Application Data
(63) Continuation of application No. PCT/US18/58531, filed on Oct. 31, 2018.
(60) Provisional application No. 62/585,041, filed on Nov. 13, 2017.

(51) Int. Cl. A62D 1/02; E21F 5/12; A62C 3/04; A62C 5/00

(52) U.S. Cl. CPC A62D 1/0071; E21F 5/12; A62C 3/0278; A62C 5/002; A62C 3/04

(57) ABSTRACT

Provided is a foamed dust composition and a method of using the foamed dust composition. The foamed dust composition contains an aqueous foam comprising a foaming agent, a foam stabilizer, water, and a rock dust. The foamed dust composition is sprayed onto coal mine surfaces to prevent coal dust explosion in the event of a fire.

### CROSS-REFERENCE TO RELATED APPLICATIONS

This application is a continuation of Application No. PCT/US18/58531, filed Oct. 31, 2018 which in turn claims the benefit of Provisional Application No. 62/585,041, filed Nov. 13, 2017, the disclosures of which are incorporated by reference into the present application.

### SUMMARY OF THE INVENTION

A foamed rock dust composition comprises an aqueous foam, a foam stabilizer, water, and a rock dust. The foamed rock dust composition is sprayed onto coal mine surfaces to prevent coal dust explosion in the event of a fire.

### BACKGROUND OF THE INVENTION

Dry powder dusting with finely ground limestone dust has been used for decades in underground coal mines to prevent and suppress fires caused by the ignition of coal dust and methane gas produced during the mining process.

In dusting the mine surfaces, it is highly desirable to have the dust powder adhere to the mine surfaces and prevent propagation of fires along exposed surfaces of unmined coal. In the event of the ignition of coal dust and gas within the mine, the shock waves from the explosion and fire will cause the loosely adhering dust to fall from the surfaces of the mine. This produces a limestone suspension that suppresses the propagation of flames through an endothermic reaction between the limestone particles and the burning coal dust and stops the fire.

In traditional stone dusting, a limestone powder is applied to the surfaces of walls and ceiling of the mine. Such dusting processes are generally dusty and wasteful. Working personnel in the dust application area have to be evacuated while the stone dusting procedure is performed because of the excessive amount of respirable dust produced in the air of the mine during the stone dust application. Furthermore, a substantial portion of the dust does not usually adhere to the wall or ceiling surfaces of the mine and falls to the floor. Such powders quickly become wet and inactive under the foot traffic and the high humidity in a typical coal mine. The dusting process must be repeated within a short time thereafter. Such repeated dusting operations will not only constantly interrupt the typical coal mine operation, but also cause added manpower and material expenses.

Applying wet rock dust or dust slurry instead of using dry powder is also known in the industry and can eliminate flying dust powders in the downstream airways. The wet dust can also adhere to the wall, ceiling, and rib surfaces by spraying. However, upon the wet dust drying out, the dried slurry usually forms a hardened cake layer on a treated mine surface. This is commonly known as “caking” of the dust powder. Limestone powders, once caked, are not as easily dispersed from the treated surfaces anymore, and their explosion prevention function is thus lost.

In the U.S., rock dust is required to meet regulations set forth by 30 CFR § 75.2 that governs underground mining. The regulations also require that all exposed surfaces of a mine be covered with a rock dust and at least 80% of the dust composition (including the coal dust itself) be non-combustible. This regulation poses a tremendous challenge for coal mine operators to comply with the regulation requirements.

As such, a need exists for an improved stone dusting process that does not suffer from the disadvantages of the dry dusting and wet dusting processes, provides a coating on a surface with readily dispersible dust particles, and satisfies the required dust level specified by the regulations.

There have been attempts to use a coating of aerated rock dust or a foamed rock dust. U.S. Pat. No. 6,726,849 describes the combination of limestone dust with a pre-generated foam comprising a foam agent and water. U.S. Pat. No. 9,456,718 discloses a method of aeration of water and a dry powder mixture comprising a rock dust and a dry powder foam agent. U.S. Pub. No. 2012/0111583 discloses a stone dusting by aerating a surfactant-treated stone dust and a foam agent. U.S. Pat. No. 8,883,868 discloses a void forming rock dust and polymer composition for the mine surface. U.S. Pub. No. 2014/0265523 describes the use of an aerated mixture of rock dust and foam agent. U.S. Pat. No. 9,228,435 offers a method of mixing a stream of foam and a stream of dust to form a foamed dust. However, none of these attempts have solved the problems of caking prevention or dust redispersibility.

A 2014 article in the coal mine magazine The Coal Age commented on the numerous and unsuccessful endeavours to use foams for mine dusting. It concluded that prior decades of exploration for the use of foam-based rock dust have failed to provide an effective solution. The article further explains that the foam rock dust has been shown to dry on the mine. Once hardened, the foam rock dust will not scour off. The government agency overseeing coal mine safety has presently determined that the current foam technology does not provide as effective inerting capability in the event of an explosion as dry rock dust.

This invention found that sufficient foam stability is required to minimize cake formation of the dust in a slow drying environment of a coal mine, and thereby enhance dispersibility of the dust after drying, as well as redispersibility of the dust after the repeated cycles of wetting and drying in a typical mine environment. When a wet foam dust is sprayed onto mine surface, the high humidity (>90%) under a typical coal mine environment significantly slows down the drying of the foam dust. Consequently, significant foam collapse takes place for most of these foams. The present invention found that such foam collapses may have caused the formation of dust cake (the “caking”) from the collapsed foam during the slow drying process. The caking makes the rock dust not dispersible into fine powder form anymore, and the caked dust then loses its function in preventing coal dust explosion. Furthermore, the constant cycles of wetting from the mine surfaces and the drying from the daytime ventilation operation results in further foam collapse and dense cake formation.

Therefore, a foamed rock dust with long-term foam stability and the capability of maintaining the dust dispersibility through repeated humid-dry cycles is highly desirable.

### SUMMARY OF THE INVENTION

None of prior art addresses foam stability and dust redispersibility issues for foamed rock dust applications. It is therefore an object of the present invention to provide an aerated rock dust using a stable aqueous foam derived from a preformed aqueous foam followed by the addition of foam stabilizer.

It is also an object of the present invention to provide a process of preparing such a foamed rock dust composition by adding the rock dust powder into an aqueous foam with a foam stabilizer.

It is also an object of the present invention to provide a process of preparing such a foamed rock dust composition by adding an aqueous slurry of rock dust into an aqueous foam containing the foam stabilizer.

It is also an object of the present invention to provide a process of transporting a stable aqueous foam from an external location over a long distance to an application site inside the coal mine, wherein the stabilized foam is mixed with rock dust and applied by spraying onto the mine surfaces.

It is also an object of the present invention to provide a process of transporting a mixture of rock dust and stable aqueous foam from an external location over a long distance to an application site inside the coal mine. The stabilized foam dust is sprayed onto the mine surfaces through some pumping means.

It is also an object of the present invention to provide an aerated rock dust coating with good adhesion for the walls, ceilings, ribs and other coal mine areas to prevent coal mine explosion.

### DETAILED DESCRIPTION OF THE INVENTION

An aqueous and foamed rock dust composition of this invention comprises (1) a cationic foaming agent, (2) an anionic foam stabilizer, (3) a rock dust, and (4) water. During the wet stage, the foamed dust of the present invention shows good adhesion to vertical mine surfaces and foam stability during spraying operation. The foam stability and void volume are unchanged upon slow-drying under a high humidity mine environment. The dried foam dust has good powder redispersibility and fine particle size distribution. During the repeated wetting and drying of the foamed dust, the powdery nature and redispersibility of the rock dust are unchanged. The foaming agent of the present invention may be of a cationic nature with a long-chain organic cation-forming compound having the general formula (I):

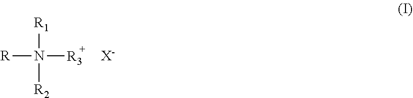

wherein R is an aliphatic hydrocarbon radical having from 8 to 24 carbon atoms; R₁ is selected from the group consisting of an alkyl group having from 1-16 carbon atoms, a hydroxyalkyl group having from 1-16 carbon atoms, a benzyl group, a group which, when taken together with the nitrogen, represents a heterocyclic radical, and any of such groups having a hydrogen atom replaced by a fluorine atom; R₂ and R₃ are selected from the group consisting of an alkyl group having from 1-6 carbon atoms, a hydroxyalkyl group having from 1-6 carbon atoms, a benzyl group, a hydrogen atom, a group which, when taken together with the nitrogen, represents a heterocyclic radical, and any of such groups having a hydrogen atom replaced by a fluorine atom; and X⁻ is an anionic counter ion.

The foaming agent may be at least one quaternary salt selected from the group consisting of dodecyltrimethylammonium bromide, dodecyltrimethylammonium chloride, tetradecyltrimethylammonium bromide, tetradecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammonium bromide, cetyl pyridinium chloride, (tallow)trimethylammonium chloride, and mixtures thereof.

The foam stabilizer of this invention may be of an anionic nature with a long-chain organic anion-forming compound having the formula (II):

R′—X₂⁻Y⁺ (II)

wherein R′ is an aliphatic hydrocarbon radical with 10 to 24 carbon atoms; X₂⁻ is an anionic group selected from the group consisting of carboxylate, sulfate, sulfonate, and phosphate; and Y⁺ is a cationic counter ion selected from the group consisting of ammonium, sodium, and potassium salt.

The foaming agent and the foam stabilizer may be present in the aqueous and foamed rock dust composition in a weight ratio of from 0.05:1 to 15:1 or preferably from 0.4:1 to 10:1.

The rock dust powder of this invention is a fine grained mineral dust such as that obtained from limestone, marble, dolomite, magnesite, Class F fly ash, silica fume, anhydrite, non-expansive clays, or fine ground mine tailings, and mixtures thereof. The stone dust particles preferably comprise at least some particles of a carbonate compound such as calcium carbonate.

Rock dust such as limestone dust is typically nonionic upon mixing with water. Due to such inert nature of rock dust, a sprayable foamed rock dust slurry of this invention may be prepared by various sequences of mixing of the powder, water, foam agent and foam stabilizer.

This invention found that a foamed rock dust slurry may also be prepared by making an aqueous foam of the rock dust with a cationic foaming agent such that the foam rise is not impeded by the presence of dust solid. The anionic foam stabilizer can then be added later into the foamed dust to make a very stable foamed rock dust such that the foam stability is unchanged until total dryness. Here, if rock dust is substituted with conventional Portland cement, total foam collapse takes place immediately after the anionic foam stabilizer is added into the foamed cement containing the cationic foaming agent.

In the present invention, the foamed rock dust slurry may be prepared over a wide range of densities or rock dust solid content without any appreciable foam collapse by adding the rock dust powder directly into the anionic foam stabilizer containing foam. When the rock dust powder is substituted with the Portland cement powder following the same procedure, appreciable and different degrees of foam collapse take place when the cement powder is added into the stabilized foam.

A sprayable foamed rock dust slurry may also be prepared by making the stabilized foam of the present invention outside of the mine and transporting the stable foam through a hose to the site inside the mine where spraying is to take place. The sprayable foamed dust can then be prepared by mixing the foam with an aqueous rock dust slurry at the job site.

Spray nozzles of various configurations may be used to spray the foamed rock dust onto the various mine surfaces, ribs, and ceilings with minimized foam collapse or foam bounce-back from the coated surface.

Due to the great foam stability of the present invention, different foam densities, speed of drying, and surface adhesion to vertical surfaces without falling may be prepared quantitatively by changing the ratio of the aqueous foam and the dust used.

The dispersant for effective dispersion of the rock dust powder may reduce the amount of water used before adding the foam. Such dispersant additives may be a sulfonate-containing plasticizer such as the lignosulfonates, or superplasticizer such as the polynaphthalene sulfonate condensate (PNS).

### Example 1—Aqueous Foam Preparation from the Cationic Foam Agent of Present Invention

A 2-5% aqueous solution by weight of a cationic foaming agent is prepared. The mixture is added into a five-quart stainless steel bowl. The content is whipped with a wire whisk at speed ten in a Hobart blender (Kitchen Aid brand) until a low-density foam having a density of 0.03-0.08 g./cc is obtained. This takes one to two minutes.

### Example 2˜Aqueous Foamed Rock Dust Preparation from Foam and Rock Dust

A 2-5% aqueous solution by weight of a foaming agent is prepared. The mixture is added into a five-quart stainless steel bowl. The content is whipped at speed ten in a Hobart blender (Kitchen Aid brand) until a low-density foam having a density of 0.03-0.08 g./cc is obtained. This takes one to two minutes. A pre-weighed amount of limestone dust is mixed using a mixing paddle with the aqueous foam from above until a uniform foamed rock dust slurry is reached.

### Example 3—Aqueous Foamed Rock Dust Preparation from Foam and a Rock Dust Slurry

Water is added into a pre-weighed amount of rock dust powder. The slurry is mixed with a mixing blade until a free-flowing aqueous slurry is achieved. 2-5% of foaming agent with a foam stabilizer based on the water content of the rock dust slurry is added into the mixture. The mixture is added into a five-quart stainless steel bowl. The content is whipped at speed ten in a Hobart blender (Kitchen Aid brand) until a low-density foam having a density less than 1.5 g./cc is obtained.

### Example 4—Preparation of an Aqueous Foam Containing a Foam Stabilizer

An aqueous foam is prepared from EXAMPLE 1, and 0.2 to 1.0 in stoichiometric amount by weight of an anionic foam stabilizer based on the cationic foaming agent is blended in with the preformed foam until a uniform foam mixture is achieved. This usually takes 1-2 minutes.

### Example 5—Preparation of a Foamed Rock Dust from Rock Dust and a Preformed Foam Containing a Foam Stabilizer

A rock dust, the amount of which by weight is 2-10 folds higher than that of the foam liquid is added into a stabilizer containing aqueous foam from EXAMPLE 4. The mixture is blended together with a mixing blade until a uniform foamed slurry is achieved. This usually takes less than a minute.

### Example 6—Preparation of a Stabilizer-Containing Foamed Rock Dust from a Foamed Rock Dust

A rock dust, the amount of which by weight is 1-10 folds higher than that of the foam liquid, is added into an aqueous foam from EXAMPLE 4. The mixture is blended together with a foam stabilizer using a mixing blade until a uniform foamed slurry is achieved. This usually takes less than a minute.

### Example 7—High Humidity Exposure Test for Foamed Rock Dust

A rectangular plastic container of 8″ (length)×8″ (wide)×4″ (depth) is partially filled with ½″ deep of water. A lid that can seal tightly over the plastic container is used for a high humidity aging test. Foamed rock dust is at ½″ thick is cast onto a 4″ wide by 4″ long fiberglass scrim that has a 4″×4″ square of styrofoam board underneath for support.

The foamed rock dust/fiberglass scrim/Styrofoam board assembly is put on top of a ¾″ tall and 4″ in diameter section of PVC pipe that is partially immersed in water within the plastic container. The container lid is then closed, and the assembly is put in a room temperature curing chamber for the humidity exposure test.

### Example 8—Test of Powder Dispersity of the Surface of a Foamed Rock Dust by Pressurized Air or Light Surface Swiping with a Soft Brush

The powderiness or powder dispersity of a dried foamed rock dust can be relatively graded by blowing horizontally over the sample surface with a 40 psi pressurized air from a ¼″ diameter pressure hose. A soft pony hair brush can also be used to lightly brush over the surface of a foamed rock dust sample for powderiness evaluation. The blown off powder from either the pressurized air or the powder dusted off by the brush can then be collected for visual examination of powderiness, fragment formation, or aggregate formation. A qualitative evaluation of the degree of powderiness also can be compared semi-quantitatively based on the amount of powder collected after the test.

### Example 9—Aqueous Foamed Rock Dust Preparation from a Preformed Foam and a Rock Dust Slurry

A stabilizer-containing aqueous foam is prepared according to EXAMPLE 4. A rock dust slurry is prepared by adding water to a rock dust. The water content is 20-60% by weight of the rock dust. A foamed rock dust slurry is then prepared by mixing the stabilizer-containing preformed aqueous foam with the rock dust slurry.

TABLE 1
FOAMED ROCK DUST ADHESION AND
STABILITY ON VERTICAL SURFACES

| | |
|---|---|
| Sample 1 | |
| (comparative) | Sample 2 |

Composition:

| | | |
|---|---|---|
| Rock dust | 300 grams | 300 grams |
| Foam added | 100 grams | 100 grams |
| | (5% foaming agent) | (5% foaming |
| | | agent/foam |
| | | stabilizer) |

½″ thick foam cast vertically on cement board:

| | | |
|---|---|---|
| % collapse of | 30% foam collapse | 0% foam |
| foam dust | in 10 minutes | collapse after |
| | | 24 hours |
| Thickness change | lost ½ of the | no loss of |
| after drying | thickness | foam |
| | | thickness |
| Foam Adhesion on | fell to ground in less | adhered well |
| vertical surface | than 5 minutes | until totally |
| | | dry |

Comparative foamed rock dust Sample 1 in TABLE 1 was prepared according to EXAMPLE 2. The foamed rock dust showed significant foam collapse as soon as the sample was made. Collapsed foam dust became very watery and flowable due to the collapsed foam. The sample fell from the vertical wall in less than 5 minutes after cast. The foamed rock dust Sample 2 of this invention containing a foam stabilizer was prepared according to EXAMPLE 5. The ½-inch-thick foamed rock dust maintained perfect adhesion to the vertical surface until it was completely dry, which took 10-24 hours. The foamed dust of sample 2 maintained fine foam bubble structure without any appreciable change in thickness for the unexpectedly long period of time of 24 hours.

TABLE 2
POWDER DISPERSITY OF FOAMED
ROCK DUST AFTER DRYING

| | |
|---|---|
| Sample 3 | |
| (comparative) | Sample 4 |

Composition:

| | | |
|---|---|---|
| Rock dust | 150 | 150 |
| Foam added | 100 grams | (5% foaming |
| | (5% foaming | agent/foam |
| | agent) | stabilizer) |

½″ thick cast on vertical surface:

| | | |
|---|---|---|
| Foamed dust | fell to the | adhered well on |
| adhesion | ground | the wall until |
| to surface | | total dryness |
| Dust | non-dispersible | dispersible |
| dispersity | with foam | powder by |
| by brush | collapse | soft brush |
| after | | |
| totally dry | | |

Comparative foamed rock dust Sample 3 from a cationic foaming agent without foam stabilizer in TABLE 2 was prepared according to EXAMPLE 2. The foamed rock dust collapsed severely in 10 minutes after preparation, and the sample fell to the ground from the vertical surface in 5 minutes after preparation. The severely collapsed foam dust upon total dryness showed very little powder formation upon brushing by a soft brush according to EXAMPLE 8.

The foamed rock dust Sample 4 of this invention containing a foam stabilizer was prepared according to EXAMPLE 6. The ½ inch thick foamed rock dust maintained a fine foam bubble structure without any foam collapse until total dryness. The sample did not show any crust formation and the dust powder dispersed readily into fine dust by applying a soft brush according to EXAMPLE 6.

TABLE 3
POWDER DISPERSITY OF FOAMED ROCK
DUST AFTER >90% HUMIDITY EXPOSURE

| | |
|---|---|
| Sample 5 | Sample 6 |

Composition:

| | | |
|---|---|---|
| Rock dust | 200 grams | 200 grams |
| Water added | 50 grams | none |
| Foam added | 50 grams | 60 grams |
| (5% foam & stabilizer) | | |
| >90% Humidity Exposure | 4 days | 6 days |
| Dust dispersity by 40 psi | dispersible | dispersible |
| air jet after drying | | |

TABLE 3 above shows that foamed rock dust Sample 5 of this invention prepared by adding a rock dust slurry into a preformed foam with stabilizer according to EXAMPLE 3 showed very good powder dispersity after exposure to >90% humidity as described in EXAMPLE 7 for 4 days.

Sample 6 in TABLE 3 shows the good powder dispersity of foamed rock dust of this invention prepared by adding a rock dust powder directly into a preformed foam with stabilizer according to EXAMPLE 5 and exposed to >90% humidity as described in EXAMPLE 7 for 6 days.

1. A foamed dust composition comprising an aqueous foam comprising a foaming agent, a foam stabilizer, water, and a rock dust.

2. The foamed rock dust composition according to claim 1, wherein the foaming agent is a cationic compound, or a mixture of cationic compounds and the foam stabilizer is an anionic compound or a mixture of anionic compounds.

3. The foamed rock dust composition according to claim 2, wherein the foaming agent is at least one quaternary salt selected from the group consisting of dodecyltrimethylammonium bromide, dodecyltrimethylammonium chloride, tetradecyltrimethylammonium bromide, tetradecyltrimethylammonium chloride, hexadecyltrimethylammonium bromide, hexadecyltrimethylammonium chloride, octadecyltrimethylammonium bromide, octadecyltrimethylammonium chloride, cetyltrimethylammonium bromide, cetyltrimethylammonium chloride, cetylbenzyldimethylammonium chloride, cetyltriethylammonium bromide, cetyl pyridinium chloride, (tallow)trimethylammonium chloride, and mixtures thereof.

4. The foamed rock dust composition according to claim 2, wherein the foam stabilizer is at least a long-chain organic anion-forming compound having a Formula (II):
R′—X₂⁻Y⁺ (II)
wherein R′ is an aliphatic hydrocarbon radical with 10 to 24 carbon atoms; X₂⁻ is an anionic group selected from the group consisting of carboxylate, sulfate, sulfonate, and phosphate; and Y⁺ is a cationic counter ion selected from the group consisting of ammonium, sodium, and potassium salt.

5. The formed rock dust composition according to claim 2, wherein the ratio of the cationic foam agent to the foam stabilizer has a weight ratio from 0.1:1 to 15:1.

6. The formed rock dust composition according to claim 5, wherein the ratio of the cationic foam agent to the foam stabilizer has a weight ratio from 0.4:1 to 10:1.

7. The formed rock dust composition according to claim 2, wherein the cationic foam agent is selected from hexadecyltrimethylammonium bromide, cetyltrimethylammonium bromide, or cetyl pyridinium chloride.

8. The formed rock dust composition according to claim 2, wherein the anionic foam stabilizer is selected from the group consisting of ammonium, sodium, and potassium salt of a carboxylic acid with alkyl chain length from C10 to C20, and mixtures thereof.

9. The formed rock dust composition according to claim 1, wherein the rock dust is selected from the group consisting of limestone, marble, dolomite, magnesite, Class F fly ash, silica fume, anhydrite, non-expansive clays, fine ground mine tailings, and a mixture thereof.

10. The formed rock dust composition according to claim 1, wherein the composition further comprises water resistant additives, water reducing plasticizers or superplasticizers, coloring dyes, pigment, or additives for making a sprayable slurry.

11. A method of dusting coal mine surfaces comprising:
(a) providing a preformed aqueous foam;
(b) providing a rock dust;
(c) combining the preformed aqueous foam with a foam stabilizer to form a stabilized foam;
(d) combining the stabilized foam with the rock dust to form a foamed material; and
(e) applying the foamed material to a mine surface.

12. The method of dusting coal mine surfaces according to claim 11, wherein the stabilized foam is transported to an application in the mine, wherein the stabilized foam is mixed at site with the rock dust, and the foamed material is sprayed to the mine surface.

13. The method of dusting coal mine surfaces according to claim 11, wherein the rock dust is a limestone dust.

14. The method of dusting coal mine surfaces according to claim 11, wherein, in the step (b), the rock dust is provided in a form of a rock dust slurry, wherein the rock dust slurry contains water and the rock dust.

15. A method of dusting coal mine surfaces comprising:
(a) providing a preformed aqueous foam containing a foaming agent and a rock dust to form a foamed dust;
(b) combining the foamed dust with a foam stabilizer to form a foamed material; and
(c) applying the foamed material to a mine surface.

16. The method of dusting coal mine surfaces according to claim 15, wherein the rock dust is a limestone dust.
